(19) United States
(12) Patent Application Publication
(10) Pub. No.: US 2021/0148321 A1
(43) Pub. Date: May 20, 2021

(54) LIQUID ATOMIZING NOZZLE INSERT WITH COLLIDING JETS

(71) Applicants: Nirmal MULYE, (US); Frank S. LOSCRUDATO, (US); Osanan L. BARROS NETO, (US); NOSTRUM ENERGY PTE. LTD., Singapore (SG)

(72) Inventors: Nirmal MULYE, Kendall Park, NJ (US); Frank S. LOSCRUDATO, Ann Arbor, MI (US); Osanan L. BARROS NETO, Commerce TWP, MI (US)

(73) Assignee: NOSTRUM ENERGY PTE. LTD., Singapore (SG)

(21) Appl. No.: 16/065,234

(22) PCT Filed: Dec. 22, 2016
(86) PCT No.: PCT/US2016/068200

§ 371 Date: Jun. 22, 2018

Related U.S. Application Data
(60) Provisional application No. 62/270,882, filed on Dec. 22, 2015.

(51) Int. Cl. F02M 61/18; B05B 1/26

(52) U.S. Cl. CPC F02M 61/18; B05B 1/26

(57) ABSTRACT

In one embodiment, an insert for a fluid nozzle is provided. The insert includes a plurality of passages oriented in included angles to produce colliding jets of a liquid at one or more focal points a specific distance away from the exits of the passages (in one example, the colliding jets of liquid increase fluid atomization and reduce liquid lengths). In one embodiment, the nozzle insert is cylindrical in shape. The insert may be housed, held, trapped or otherwise in material connection with an outer nozzle. The colliding jets of liquid may utilize the kinetic energy carried in particle to particle collision to improve liquid break-up in order to form smaller particles (resulting in high vaporization rates and shorter liquid lengths).

### FIELD OF THE DISCLOSURE

The present disclosure relates generally to an apparatus and method for creating an atomized liquid (which liquid may be volatile or non-volatile). In one embodiment, the present disclosure is directed to a fluid spray nozzle (or injector) used in the fluid delivery industry.

### BACKGROUND OF THE DISCLOSURE

Improving the atomization of liquids (e.g., a volatile or a non-volatile liquid, such as water or certain coatings, respectively) for use in fluid delivery systems is an important aspect of nozzle design. A key aspect is the liquid particle size or the size of the liquid droplets as they leave the nozzle for application of the liquid for the intended purpose (such as atomization in an air stream or fine droplet application onto a surface). The atomization of water and/or alcohol, for example, is of particular importance to internal combustion (spark or compression ignition) engines. Conventional single hole, multi-hole and “swirl” type universal nozzles (which may be single piece design or multi-piece design with an outer, inner and securing mechanism) provide sub-optimal atomization of liquids (these conventional designs typically use an air shear and/or a swirl type atomization mechanism). The disclosed invention, through the application of jet-to-jet colliding geometries, provides for atomization while maintaining simple integration to universal nozzles, including both multi-piece and single piece nozzle designs.

Achieving effective atomization of liquids (whether for cooling, knock reduction, NOx reduction and/or improved combustion efficiency) is an important aspect of engine design and operation and provides significant advantages to the internal combustion engine.

Both liquid fuels and water are typically injected into engines. Fuels can be diesel-type fuels, gasoline (petrol), alcohols, and mixtures thereof. Alcohols include ethanol and methanol, which are commonly blended with gasoline. Water is also often injected into engines to provide an internal cooling effect, knock and/or NOx reduction. Because of the large coefficient of expansion provided by liquid water it has the advantage of being converted to steam during combustion.

Modern engines typically use fuel injection to introduce fuel into the engine. Such fuel injection may be by port injection or direct injection. In port injection, fuel injectors are located at some point in the intake track before the cylinder and the fuel is introduced into the air stream (which is generally close to atmospheric pressures for normally aspirated operation and up to 2-3 atm for forced induction applications). Atomization of fuels and other liquids injected into engines is important, as only fuel vapor can participate in combustion. Optimally, any injected liquid is atomized prior to contact of a stream of injected liquid with any interior surface of the engine. If liquid contacts surfaces at any time prior to combustion, such liquid can wash away lubricants and/or pool or puddle—resulting in sub-optimal combustion. Pooled fuel during combustion causes carbon deposits, increased emissions, and reduced engine power.

Evenly distributed sprays of water are important for heat transfer on heat exchanger surfaces (as utilized in boosted high performance engine applications), wherein water is sprayed onto a heat exchanger to increase heat transfer efficiency and provide additional cooling capacity. A common application in the automotive industry is the utilization of water or alcohol sprays onto the exterior of charge air heat exchangers to further lower the charge air temperature prior to introduction into the combustion chamber.

Fine droplet size and short liquid lengths are extremely important for the spray of, for example, water and/or alcohol into the intake track of an internal combustion engine, in order to maximize heat transfer from the hot air charge in a boosted internal combustion engine to the injected water-alcohol spray. Excessively large spray droplets can be carried into the combustion chamber, but they poorly participate in combustion, while washing engine lubricants from friction surfaces in the combustion chamber (leading to undesirable premature wear or possible failure of the components). In addition, sprays with long liquid lengths impinging on surfaces internal to the air intake track of an internal combustion engine may pool or coalesce into large puddles (which, if ingested by the engine, can cause significant damage, and in extreme cases, cause hydraulic lock of the engine).

Besides combustion engines, atomization of fluids is also extremely important for creating medical aerosols, pharmaceutical or industrial coatings, as well as devices such as humidifiers.

Evenly distributed and small droplet size is also important for coating applications (including adhesives). Fine particle sizes permit uniform coating thickness and even exposure to ambient air, allowing even curing of the coating or adhesive.

The spray configuration in conventional fuel injectors or atomizers typically consists of one or more jets or streams aimed outwards from the injector. However, this configuration is limited, and often results in impaction of liquids on the intake manifold and intake port walls, causing a film to form which needs to be accounted for in transient fueling calculations.

An approach to effective atomization is the use of high pressure liquid injection and small orifices, but high pressure systems have increased parasitic drag, in the form of added power required to drive the pump to higher pressures, are typically more expensive and prone to failure, and small orifices are typically prone to clogging.

Also an approach to effective atomization is to use air shear with the liquid, where high pressure fast moving air is used to shear the liquid stream to achieve atomization. This approach has its own limitations in terms of breaking the liquid droplets. In addition, pressurized air must be provided by a secondary system and is most often supplied via a mechanically driven or electrically driven pump, which imposes high parasitic drag on the engine.

Colliding jets of liquid are known to provide good atomization. See N. Ashgriz, “Colliding Jet Atomization,” in Handbook of Atomization and Sprays, N. Ashgriz (ed.), 2011, pp 685-707, http://dx.doi.org/10.1007/978-1-4419-7264-4_30.

Colliding jets are well known in liquid fueled rocket engines, as a means of mixing the fuel and the oxidizer together. Injectors for internal combustion engines differ from known rocket engine nozzles in that rocket engine nozzles are not metered devices, whereas injectors for internal combustion engines are designed to deliver, on command, a specific quantity of a liquid. This requires careful control of the flow rate over time, which is traditionally achieved via a solenoid, but can also be controlled via hydraulic pilot actuation, hydraulic amplification, piezo-electric stack, pneumatic means, or other methods.

### SUMMARY OF THE DISCLOSURE

In one embodiment, disclosed is an insert for a fluid nozzle that produces an atomized liquid. In an embodiment, the nozzle and the insert may be cylindrical in shape or cylindrical-like in shape. Regardless of the shape, in an embodiment, a pressurized source of a liquid provides the liquid that is fed to the nozzle, wherein a body of the nozzle has a liquid inlet at a proximal end and a liquid outlet at a distal end. The body of the nozzle may have a generally circular cross section with a central longitudinal axis, and may include a center cavity within the nozzle in which the insert is located. The insert may have the same central axis of symmetry and longitudinal axis as the body of the nozzle. The insert may have a proximal end and a distal end. Two or more passages may pass through the insert (in one example, each passage has substantially the same diameter “d” and each passage is substantially uniform in cross-section). Each passage may terminate at the distal end of the insert. The insert may be housed within the body of the nozzle such that the insert passages at the distal end of the insert (and at the distal end of the body of the nozzle) are exposed from the distal end of the body of the nozzle. Each insert passage may be arranged such that it is aligned with another (or others) to form a “colliding set” with an included angle. Fluid jets exiting the distal end of the insert through each passage substantially impinge on one another at a specified point (which is a specific position away from the exits of the passages). Pressurized liquid may be forced from the proximal end of the nozzle, through the center cavity of the nozzle, to the insert. The liquid may enter into contact with the insert, which may guide the flow of liquid to the insert passages (wherein the liquid may then flow through the passages to direct jets of the pressurized liquid out of the distal end of the nozzle at a focal point that is external to the insert). The substantial impingement of pressurized liquid jets at the focal point, or points, creates an atomized form of the liquid.

The insert may be housed within a nozzle that does not have a cylindrical exterior form, or may be housed in a unit containing several nozzles (within each of which nozzles may be housed a respective insert).

The insert may be connected to a nozzle having a valving means for providing a precise quantity of liquid flow at a precise start time and a precise stop time.

An insert may be housed in one or more nozzles which may inject the fluid into one or more ports, or any location in the air intake track(s) or exhaust track(s), for application in an internal combustion engine.

In one embodiment, the insert may be useful for a multitude of fluids, such as liquid fuels, oxidizers, fuel-alcohol blends (including Ethanol blends ranging from E0 to E100), water, salt, urea, adhesive, finish coatings, paint, lubricants or any solutions or mixtures.

In one embodiment, the insert may be constructed of any grade of steel, aluminum, brass, copper, alloys, composites (including graphite, ceramic, carbon or fiber blends), or a multitude of plastic chemistries.

In one embodiment, the insert may comprise a range of features and geometries including a range of cylindrical dimensions (with a minimum height of X and a minimum outer diameter of Y); a quantity of orifice passage holes which may have a minimum quantity of two holes; a range of orifice hole diameters, which may have a minimum size of 100 um; one or more “colliding sets” of passages; a range of included angles which may have a minimum angle of 40 degrees and a maximum angle of 160 degrees; and one or more “colliding jet” focal points (such a “colliding jet focal point” refers to a focal point at which ejected fluid from a “colliding set” of passages meet).

The aforementioned insert may be pressed or welded into an outer nozzle, or may be threaded and fastened into an outer nozzle, or may be captured by an inner plug within the outer nozzle, or may be captured by a spring within the inner nozzle, or may be pinned transversely into the outer nozzle, or may be held within the outer nozzle with an annular clip.

### BRIEF DESCRIPTION OF THE DRAWINGS

These and other features, aspects, and advantages of the present invention will become better understood with regard to the following description, appended claims, and accompanying drawings (some of the drawings are not drawn to scale and some of the drawings are drawn at the indicated scale; further, where scale and/or dimensions are provided, they are provided as examples only) wherein:

FIG. 1 shows (as a 3D isometric rendering) a nozzle insert according to an embodiment of the present invention.

FIGS. 2A, 2B and 2C show (in a number of 2d illustration views) a nozzle insert according to an embodiment of the present invention.

FIG. 3 shows (as a sectioned rendering) a nozzle insert within an outer nozzle housing according to an embodiment of the present invention.

FIG. 4 shows (as a section view) a nozzle insert within an outer nozzle outer housing according to an embodiment of the present invention.

FIGS. 5A and 5B show (as a side view and a section view, respectively) a threaded nozzle insert (including cap feature) according to an embodiment of the present invention.

FIG. 6 shows an assembly of a threaded nozzle insert (including cap feature) within a threaded outer nozzle housing according to an embodiment of the present invention.

FIGS. 7A and 7B show (as an isometric illustration and a section illustration, respectively) a cylindrical nozzle “pill” insert according to an embodiment of the present invention.

FIGS. 8A and 8B show two examples of placement of nozzles in an automotive four cylinder engine according to embodiments of the present invention.

FIG. 9 shows a side view of a distal end of a nozzle insert according to an embodiment of the present invention.

FIG. 10 shows a top view of a distal end of a nozzle insert according to an embodiment of the present invention.

FIG. 11 shows a distal end of an insert according to an embodiment of the present invention.

FIG. 12 shows a diagram of liquid jet collision according to an embodiment of the present invention.

### DETAILED DESCRIPTION OF DISCLOSURE

In one embodiment, an insert is provided for a liquid injection nozzle. The liquid may be for injection into reciprocating, or rotary, internal combustion engines. Such liquids may be fuels, water, or aqueous solutions. The insert may be housed within a nozzle. The insert may have a plurality of passages that emit at least two jets of the liquid (under pressure) aimed at an impingement point. The jets of liquid may substantially impinge on each other. The collision of the jets at the impingement point(s) efficiently atomizes the liquid.

Compressed liquids, such as water or liquid fuels, possess a specific potential energy, or SPE (in units of kJ/kg), where SPE=ΔP/ρ, where ΔP is the pressure drop across a fuel nozzle in kN/m², and ρ is liquid density in kg/m³. Thus, for water at 10 bar pressure difference and density of 1000, SPE=1 kJ/kg. When expanded ideally this will result into a jet velocity of v=(2ΔP/ρ)½=(200) ½=100 m/s. When two or more such jets collide some of this kinetic energy is converted into heat, causing a portion of the liquid to evaporate, thus creating a very powerful additional mechanism of disintegration (besides shear and turbulence disintegration mechanisms). As compared to water, which has the largest latent heat, other liquid fuels, such as gasoline or alcohols, will exhibit a significantly improved atomization at significantly less pressures and higher orifice diameters.

In one embodiment, the theoretical velocity V (or speed) of the liquid jet coming out of the nozzle is greater than 10 m/s. In other examples, V may be 20 m/s, 30 m/s, 50 m/s, 75 m/s, 100 m/s or greater.

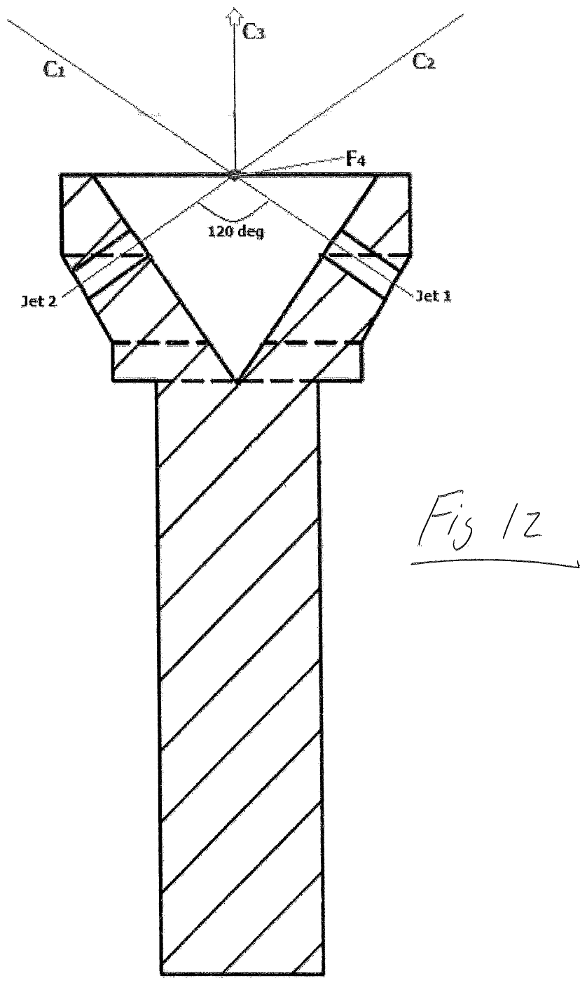

In various embodiments, provided are superior atomization, shorter liquid spray length and finer droplet sizes (relative to certain conventional liquid spray nozzles). In one specific example, the sharp inward angle of the jets (which allows the jets to impinge substantially upon one another a short distance from the exit of the passage) provided by the configuration of liquid passages in the insert, result in substantial improvements in both atomization and liquid length over non-impinging conventional techniques (thereby providing very efficient atomization in close proximity to the exit face of the passages). These improvements are due at least in part to the impact force being proportional to the normal force the jets make relative to one another. With respect to such normal force, see FIG. 12 showing a first liquid jet, Jet 1, having a velocity V₁ colliding at focal point F₄ with a second liquid jet, Jet 2, having a velocity V₂, wherein the first liquid jet and the second liquid jet form an included angle of 120°. The impact of the first and second liquid jets form resulting components C1 and C2, as well as a forward component C3, as shown.

Further, in a nozzle according to an embodiment there is no metering or actuation so device size, flow rate, and packaging are much less constrained than a metered device.

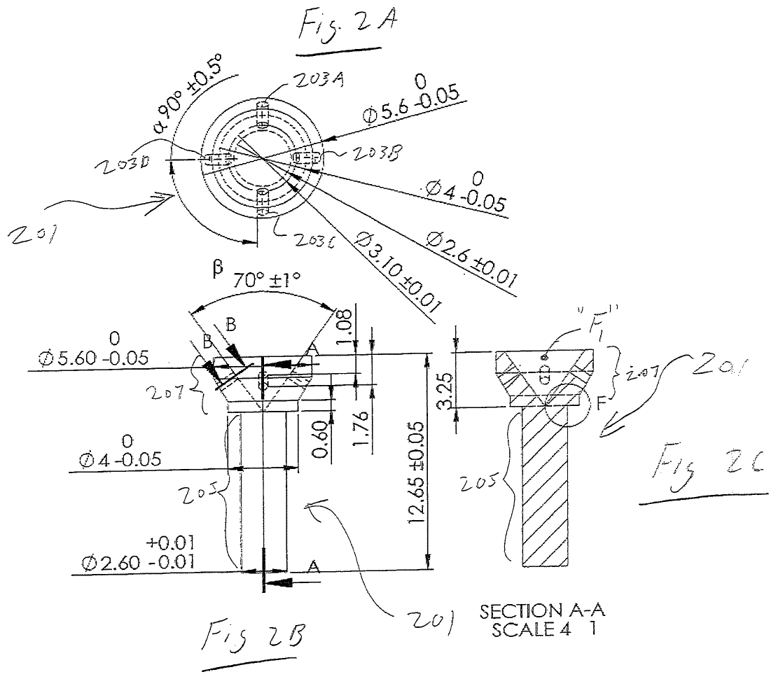

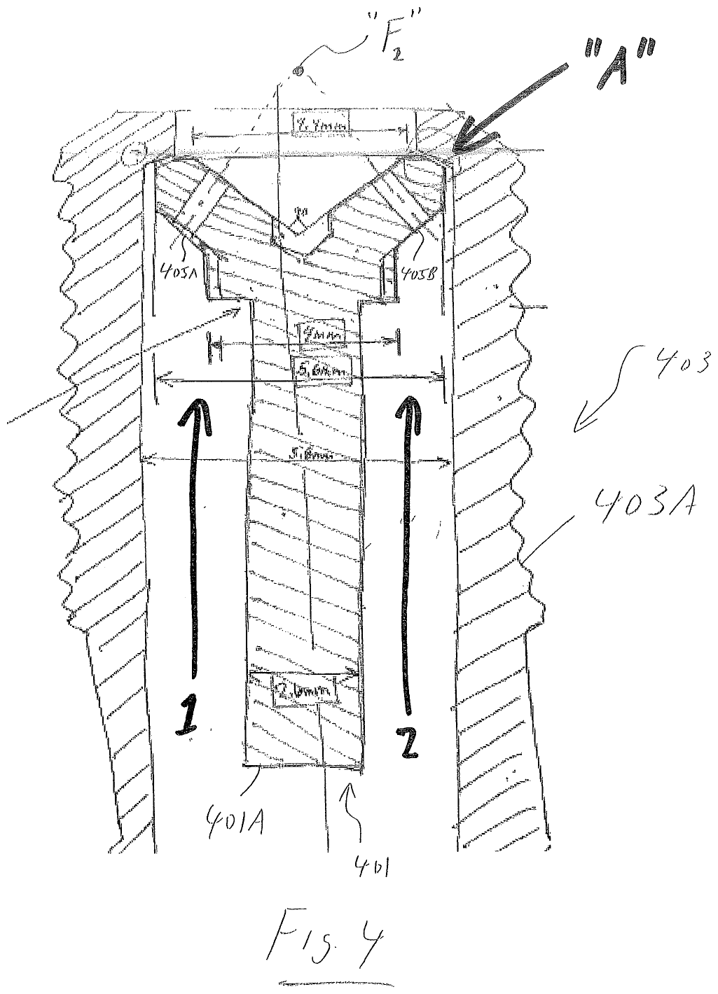

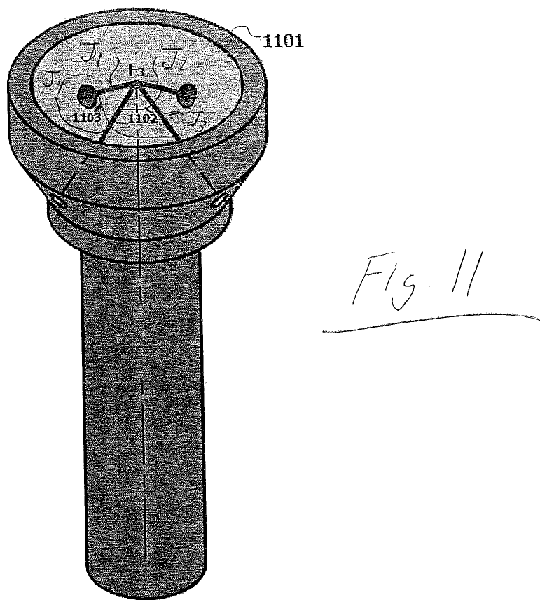

In an embodiment, an apparatus comprises a nozzle insert that produces an atomized liquid. The apparatus may further comprise a pressurized source of a liquid which feeds the liquid to a nozzle in which is housed the insert. The body of the nozzle may have a liquid inlet and a liquid outlet, wherein the nozzle housing is cylindrical in shape. The nozzle housing may have a cavity within, wherein the insert is located downstream of the nozzle liquid inlet, and upstream of the nozzle outlet. The insert may have a generally circular cross section with a central axis. The insert may be aligned on the same longitudinal central axis as the nozzle. The insert may have a proximal end and a distal end, wherein two or more passages pass through the insert. Each passage may originate from a location between the insert proximal and distal ends and may terminate at the distal end of the insert. The passages may be arranged such that each is aligned with one or more others to form an included angle, and the passages may provide for fluid jets exiting the distal end to substantially impinge on one or more others at a specified distance away from the distal end of the insert (e.g., along the central longitudinal axis of the insert). Pressurized liquid is forced through the nozzle, and consequently to the insert housed within the nozzle. The liquid flows around or through the insert to the passages at the distal end of the insert, where each passage passes through the insert to direct a jet of the pressurized liquid out of the distal end at a focal point (see, e.g., focal point F₁ in FIG. 2C, focal point F₂ in FIG. 4, focal point F₃ in FIG. 11 and focal point F₄ in FIG. 12) external to the insert. The substantial impingement of pressurized liquid jets at the focal point, or points, creates an atomized form of the liquid.

Various embodiments are characterized by a plurality of passages (or holes) through the distal end of the insert. There may be two or more such passages (the passages may be of the same diameter or different diameters). The passages may form “colliding sets” of two or more passages (e.g., of the same diameter), wherein such colliding sets may be characterized by the included angle formed by the passages of the “colliding set”.

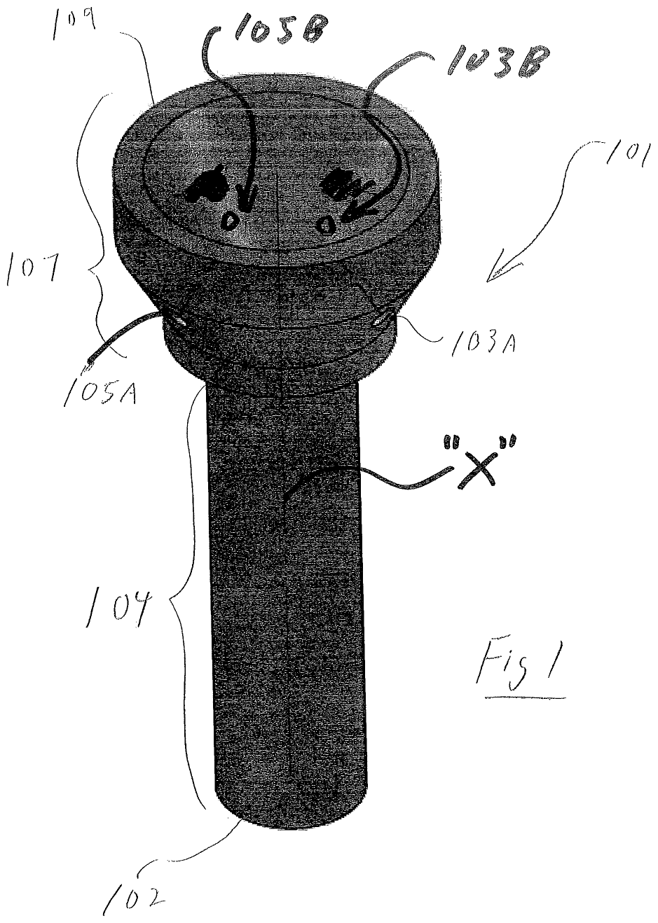

FIG. 1 is a rendering of an insert 101 according to an embodiment of the present invention. Insert 101 has a generally cylindrical cross section and a plurality of passages. Insert 101 has a proximal end 102 and a distal end 109. One passage has passage entrance face 103A and passage exit face 103B. Another passage has passage entrance face 105A and passage exit face 105B. The passages pass through an expanded diameter section 107 of the insert 101 to the distal end 109 of the insert, wherein the passages exit from a conical (or cone-shaped) feature at the distal end of the insert 101. The passages are aligned to form an included angle. There is also a focal point, aligned to the central longitudinal axis “X” of the insert 101, at which jets of liquid exiting the passages substantially impinge on one other to form an atomized spray. The narrower portion 104 of insert 101 has a “minor diameter”.

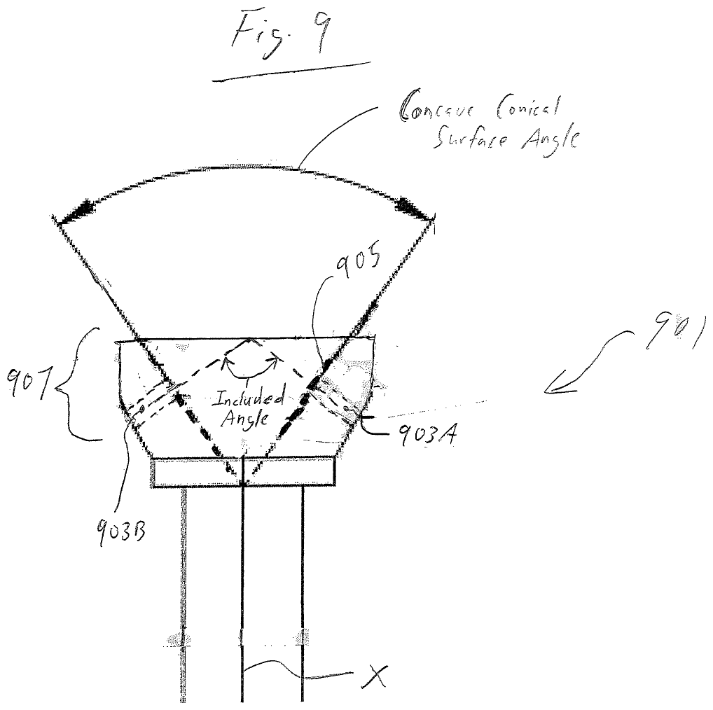

Referring now to FIG. 9 (showing certain details of the distal end of insert 901), it is seen that the expanded diameter section 907 includes passages 903A and 903B. Expanded diameter section 907 also includes concave conical surface 905. The “included angle”, as defined herein, is the interior angle of the imaginary cone formed by the alignment of the angled passages, which cone is centrally aligned to the longitudinal axis of the nozzle (with respect to FIG. 9, passages 903A and 903B). The angle formed between the longitudinal central axis of the insert (with respect to FIG. 9, central axis X) and a central axis of a passage intersecting the central longitudinal axis of the insert when projected from the passage is equal to ½ of the included angle. Each included angle may have associated therewith one or more focal points a given distance from the distal end of the insert (wherein the distal end of the insert is exposed from the nozzle housing, permitting the liquid to exit the nozzle housing at the distal end of the nozzle housing). Further, the concave conical surface angle is also shown in this FIG. 9.

See also FIG. 11, showing a 3-dimensional view of a distal end of insert 1101. In this FIG. 11, the included angle is shown by the imaginary pyramid formed by four impinging jets (J₁, J₂, J₃ and J₄), which jets impinge at point F3. In this imaginary pyramid, it can be seen that each corresponding pair of jets form an included angle which is bisected by the longitudinal axis of the insert. Two jets form included angle 1102 and another two jets form included angle 1103, each of which angle is equivalent to 120 degrees in this embodiment.

Referring now to FIGS. 2A, 2B and 2C, shown is a two dimensional diagram with plan view (FIG. 2A), side view (FIG. 2B) and section view (FIG. 2C) of an insert 201 with four passages 203A, 203B, 203C and 203D. In this embodiment the insert is cylindrical in shape, with multiple diameters and a conical feature at the distal end of the insert 101, through which conical section the fluid passages 203A, 203B, 203C and 203D are arranged perpendicular to the conical surface on the distal end. These passages form an included angle (of, for example, 110 degrees) with one another. Fluid flowing from the proximal end of the nozzle flows around the smaller cylindrical section 205 of insert 201 and is carried to the expanded diameter section 207 of the insert, and flows through the passages 203A, 203B, 203C and 203D to the distal end of the insert 201 when the insert 201 is housed within an outer nozzle (not shown). In this example, the conical section has an angle of 70 degrees.

In an embodiment, the insert is held within the outer nozzle housing and is seated against an annular surface within the outer nozzle housing (see arrow “A” in FIG. 4) at the distal end of the outer nozzle housing, which outer nozzle housing has an extended passage passing through the center longitudinal axis of the outer nozzle housing to permit the flow of pressurized fluid from the proximal end of the outer nozzle housing, through the insert, and exiting the distal end of the outer nozzle housing through the passages of the insert.

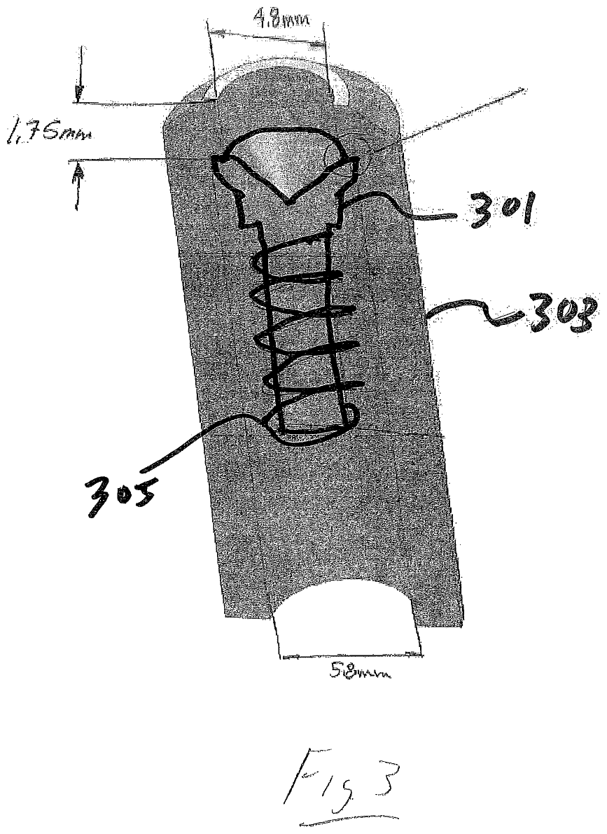

Referring now to FIG. 3 shown is an isometric section rendering of insert 301 held within an outer nozzle housing 303. The insert 301 is seated within the outer nozzle housing 303 at the distal end of the insert 301, against an axial surface within the outer nozzle housing 303 (the seal may be aided via use biasing spring 305). The majority of the distal end of the insert 301 is exposed through the distal end of the outer nozzle housing 303, permitting the colliding spray to exit the insert 301 and the outer nozzle housing 303. The insert 301 and the outer nozzle housing 303 are in material contact with one other, forming a seal, which seal is sufficient to permit the majority of the fluid entering the outer nozzle housing 303 to exit the outer nozzle housing 303 through the passages in the insert 301.

Referring now to FIG. 4, shown (as a section view) is an insert 401 housed within a nozzle housing 403 according to an embodiment of the present invention. In this embodiment, the nozzle housing 403 has an outer cylindrical surface that is threaded (see threads 403A). Also shown in this FIG. 4 are passages 405A, 405B, through which liquid is ejected after the liquid is provided (e.g., in pressurized form) from the proximal end of nozzle housing 403 (see arrows “1” and “2” showing the liquid path in this cross sectional view). In this example, the proximal end 401A of the insert 401 is flat. In other example, the proximal end of the insert may be, for example, rounded-off or wedge-shaped.

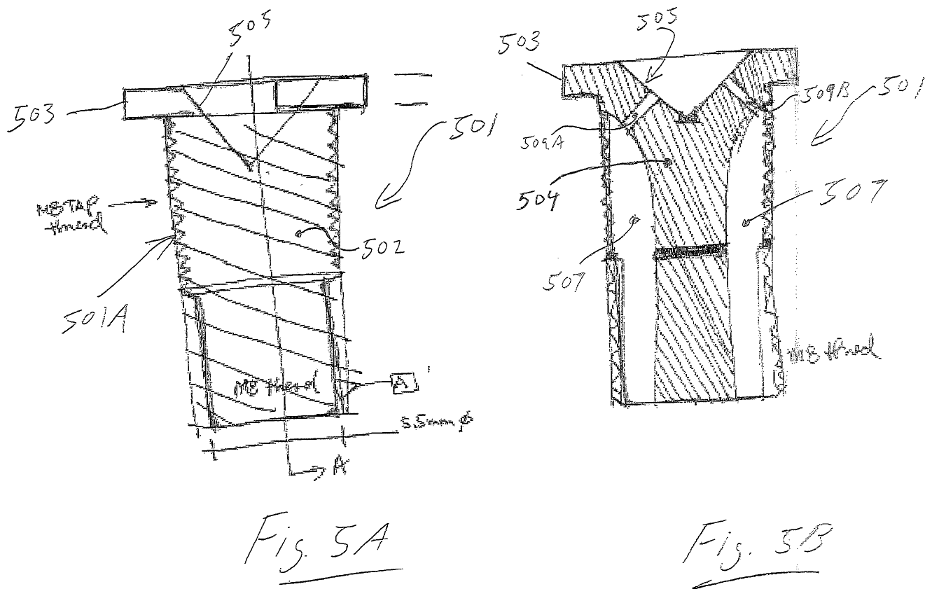

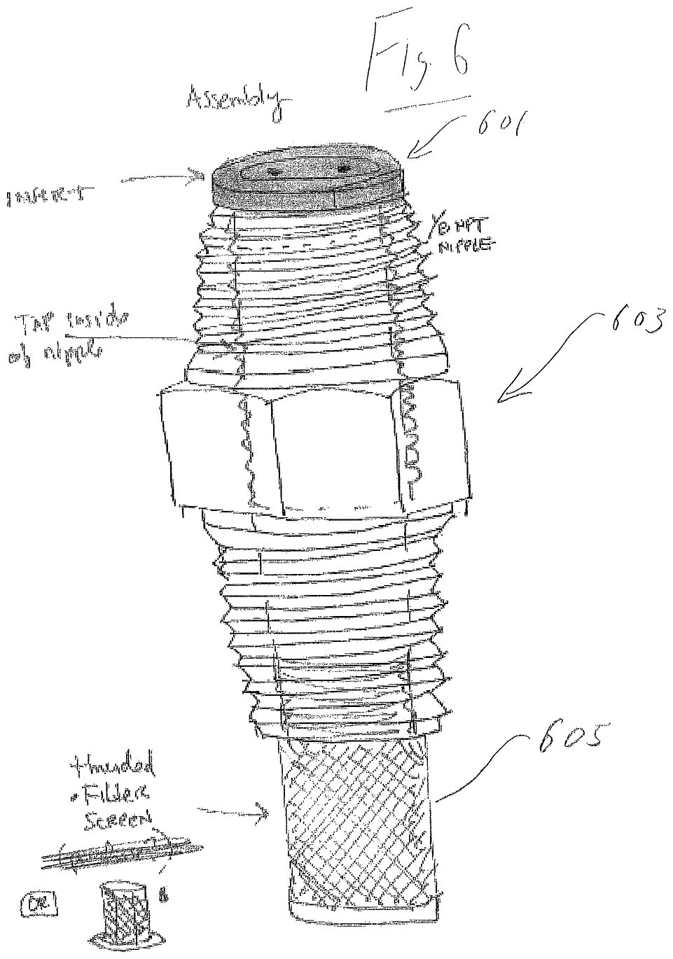

Referring now to FIGS. 5A and 5B, shown (as a side view and a section view, respectively) is a threaded nozzle insert (including cap feature) according to an embodiment of the present invention. As seen, in this embodiment the insert 501 comprises a cylindrical casing 502, wherein a portion of the outer cylindrical surface of the insert casing 502 is threaded (see threads 501A) and wherein the insert 501 has a shoulder cap 503 at a distal end of an insert core 504. Further the insert 501 includes a concave conical surface 505 at the distal end of the insert core 504 (the concave conical surface 505 being aligned to a longitudinal axis of the insert 501). Further still, the insert 501 includes passages 509A, 509B which pass through a section of the distal end of the insert core 504. These passages are oriented radially to exit the concave conical surface 505 at the distal end of the insert 501. When the insert is threaded into a housing (see, e.g., FIG. 6), fluid flows from the proximal end of the insert 501 and passes in, through or along the space 507 between the outside of the insert core 504 and the inside of the insert casing 502 to the angled passages (which passages emit jets of liquid which exit the concave conical surface 505 of the insert 501 at the distal end). The jets of fluid are oriented at an included angle and substantially impinge on one another, producing an atomized form of the fluid at the distal end of the insert.

Referring now to FIG. 6, shown is an assembly of a threaded nozzle insert (including cap feature) within a threaded outer nozzle housing according to an embodiment of the present invention. The insert 601 is screwed into the distal end of the nozzle housing 603, which nozzle housing 603 corresponds to a conventional hex pipe fitting with tapered pipe threads at both ends (the threads can be any standard of tapered pipe thread including National Pipe Thread (NPT) standard form, British Standard Pipe (BPT) thread or any other standardized tapered pipe thread). A filter 605 is installed at the proximal end of the nozzle housing 603.

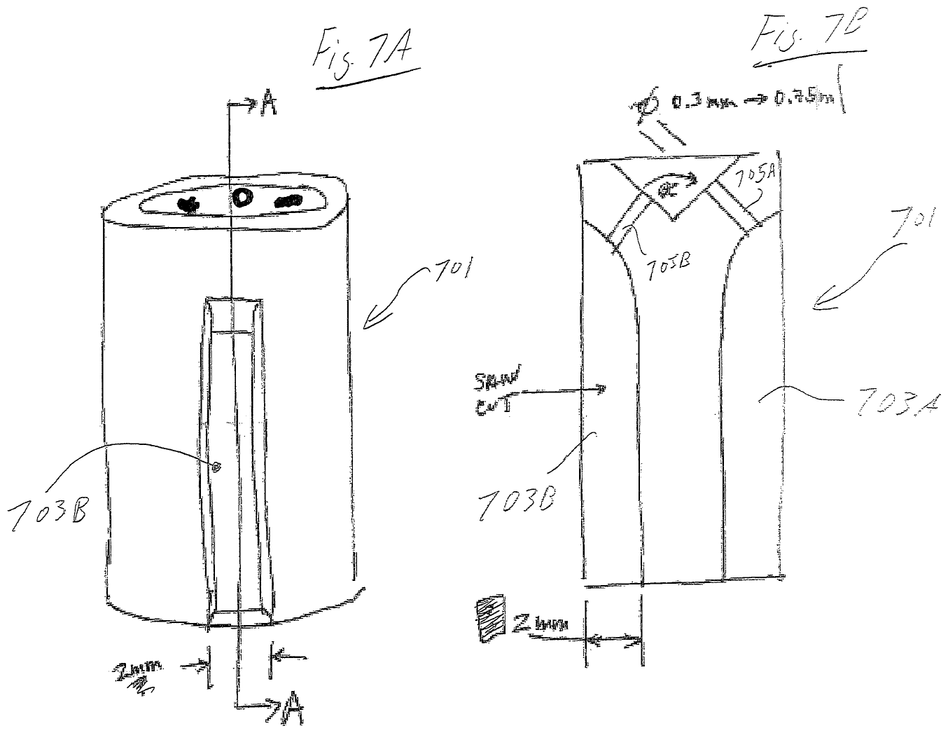

In another embodiment (see, for example, FIGS. 7A and 7B), an insert has a cylindrical body, with a proximal end and a distal end. A concave conical feature is located at the distal end of the insert. The outer surface of the cylinder is interrupted by grooves, slits or slots (which may be of square, rectangular, triangular, circular or parabolic section) which run longitudinally from below the distal end down to and through the proximal end, wherein the grooves, slits or slots do not extend upward to the distal end, and do not interrupt, break, or intersect the distal end. The location of these grooves, slits or slots correspond to the position of one or more passages, which passages are perpendicular to the exterior end conical face and extend toward the proximal end and align with the longitudinal grooves, slits or slots. The passages are oriented to form an included angle with one, or more, additional passages, at an apex which is aligned to a central longitudinal axis of the insert. This embodiment is installed into a nozzle housing, with the distal end exposed through the distal end of the nozzle housing, and through which nozzle housing fluid flows from the proximal end through the longitudinal grooves, slits or slots of the insert to the angled passages (wherein the passages emit jets of fluid which substantially impinge on another to product an atomized form of the fluid).

Referring now more particularly to FIGS. 7A and 7B, shown (as an isometric illustration and a section illustration, respectively) is a cylindrical nozzle “pill” insert according to an embodiment of the present invention. The insert 701 of this embodiment has a uniform diameter and longitudinal grooves, slits or slots (see 703A and 703B). As seen in the section view (FIG. 7B), the grooves, slits or slots 703A, 703B are aligned with the passages 705A, 705B which pass into the concave conical feature at the distal end of the insert 701. In one specific example, the grooves, slits or slots may be made via saw cut. This insert 701 may, in one embodiment, be inserted into a nozzle housing at a first end of the nozzle housing (such first end having a hole with a diameter sufficiently large to receive the insert 701) and captured in the nozzle housing at a second end of the nozzle housing (such second end of the nozzle housing having a hole with a diameter smaller than the diameter at the first end and sufficiently small to stop movement of the insert 701 past the hole at the second end). That is, the insert 701 may be captured within a nozzle housing in a manner similar to that shown with respect to insert 401 and nozzle housing 403 of FIG. 4.

In another embodiment, the nozzle housing has a single central inlet through which liquid flows, the nozzle housing has a single central outlet through which the insert is exposed, and fluid flow exits the nozzle insert.

In another embodiment, the insert is not materially connected to the nozzle housing and is in close proximity to the nozzle housing distal end.

In various embodiments, the number of fluid passages may be 2 or more, 3 or more, 4 or more, 5 or more, 6 or more, 7 or more, 8 or more, 9 or more, 10 or more, 11 or more, 12 or more, 13 or more, or 14 or more.

In various embodiments, the included angle formed by two or more fluid passages ranges from about 40 degrees to about 160 degrees. In other embodiments, the included angle is between about 90 degrees and about 130 degrees. In other embodiments, the included angle may be equal to or greater than about 40 degrees, about 45 degrees, about 50 degrees, about 60 degrees, about 70 degrees, about 80 degrees, about 90 degrees, about 100 degrees, about 110 degrees, about 120 degrees, about 130 degrees, about 140 degrees, about 150 degrees, or about 160 degrees.

In various embodiments, the pressure applied to the liquid that is supplied to insert via the nozzle housing may range from about 0 psi to about 500 psi or greater. For example, the pressure may be up to about 5 psi, about 10 psi, about 15 psi, about 20 psi, about 25 psi, about 30 psi, about 40 psi, about 50 psi, about 60 psi, about 70 psi, about 80 psi, about 90 psi, about 100 psi, about 150 psi, about 200 psi, about 250 psi, about 300 psi, about 350 psi, about 400 psi, about 450 psi, about or about 500 psi or greater, or any value therebetween.

In one embodiment, the fluid is a volatile fuel of any gasoline-alcohol blends including (but not limited to): E0, E5, E10, E15, E20, E25, E30, E35, E40, E50, E60, E70, E75, E85, E90, E95, E96, E97, E98, E99, and E100.

In another embodiment, the liquid is water.

In another embodiment, the liquid is water and an alcohol, or any mixture thereof.

In another embodiment, the liquid is water and salt, or any mixture thereof.

In another embodiment, the liquid is water and urea, or any mixture thereof.

In an embodiment, the insert is constructed from one or more of: a grade of stainless steel, a grade of steel, a grade of aluminum alloy, a grade of brass, a grade of copper and its alloys, a grade of plastic, a grade of graphite, and/or any combination thereof.

In another embodiment, each passage of a “colliding set” of two or more passages are of different hole diameters.

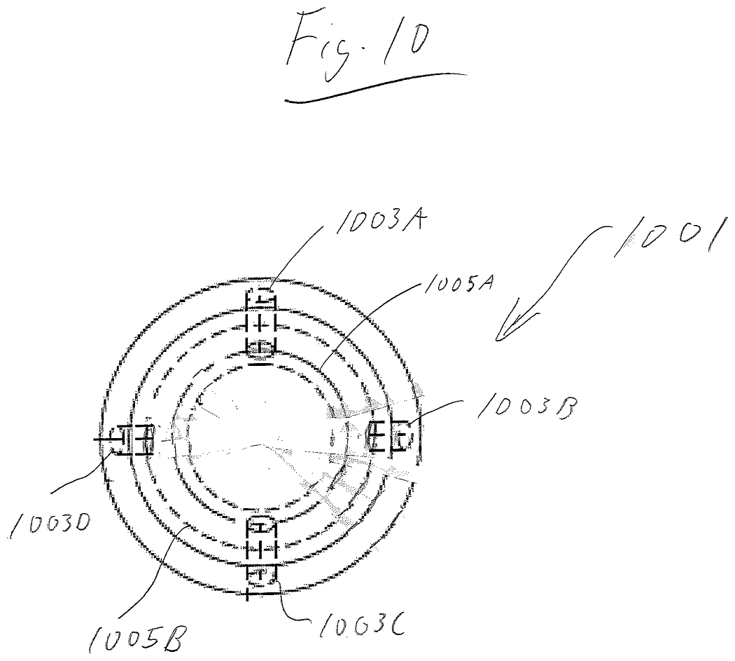

In another embodiment, a plurality of “colliding sets” of two or more passages are present, each of the “colliding sets” share the same focal point, and each of the “colliding sets” have different included angles and are located at different “virtual circles” In this regard, see, for example, FIG. 10, showing a top view of a distal end of insert 1001. Fluid passages 1003A, 1003B, 1003C and 1003D are arranged perpendicular to the conical surface on the distal end of the insert. A first virtual circle 1005A is formed tangent to the points of intersection of the passages 1003A and 1003C to the exit cone surface at the distal end. This first virtual circle refers to a given location (proximally or distally) along the conical surface at the distal end and is co-axial with the longitudinal axis of the insert. Further, a second virtual circle 1005B is formed tangent to the points of intersection of the passages 1003B and 1003D to the exit cone surface at the distal end. This second virtual circle refers to a given location (proximally or distally) along the conical surface at the distal end and is co-axial with the longitudinal axis of the insert. The first virtual circle may be closer to the distal end of the insert than is the second virtual circle or the first virtual circle may be further from the distal end of the insert than is the second virtual circle.

In another embodiment, a plurality of “colliding sets” of two or more passages are present, each of the “colliding sets” have a specific focal point different than the other, and each of the “colliding sets” has the same included angle and is located at different virtual circles.

In another embodiment, a plurality of “colliding sets” of two or more passages are present, each of the “colliding sets” have a specific focal point different than the other, and each of the “colliding sets” has different included angles and is located at the same virtual circle.

In another embodiment, a plurality of “colliding sets” of two or more passages are present, each of the “colliding sets” have a specific focal point different than the other, and each of the “colliding sets” has different included angles and is located at different virtual circles.

In another embodiment, the insert is cylindrical in shape and has a maximum outer diameter ranging from about 2 mm to about 45 mm. For example, the maximum outer diameter may be equal to about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 20 mm, about 25 mm, about 30 mm, about 35 mm, about 40 mm or about 45 mm or greater.

In another embodiment, each passage is of about uniform cross section with a diameter “d”. The diameter may range from about 80 um to about 1000 um or greater. For example, the diameter may be about 80 um, about 90 um, about 100 um, about 110 um, about 120 um, about 130 um, about 140 um, about 150 um, about 160 um, about 170 um, about 180 um, about 190 um, about 200 um, about 210 um, about 220 um, about 230 um, about 240 um, about 250 um, about 260 um, about 270 um, about 280 um, about 290 um, about 300 um, about 310 um, about 320 um, about 330 um, about 340 um, about 350 um, about 360 um, about 370 um, about 380 um, about 390 um, about 400 um, about 500 um, about 600 um, about 700 um, about 800 um, about 900 um, about or 1000 um or greater. In one specific example, the diameter is about 100 um to about 600 um. In another specific example, the diameter is about 200 um to about 450 um.

In another embodiment, each fluid passage is arranged such that it is aligned with one or more others to form an included angle, wherein each fluid jet exiting the distal end substantially impinges on one or more others, at a specified distance away from the distal end of the insert, along a central Z axis of the nozzle body (wherein the jets form a “colliding set of jets”).

In another embodiment, the insert and/or nozzle may be made by electrical discharge machining (EDM) and/or spark machining.

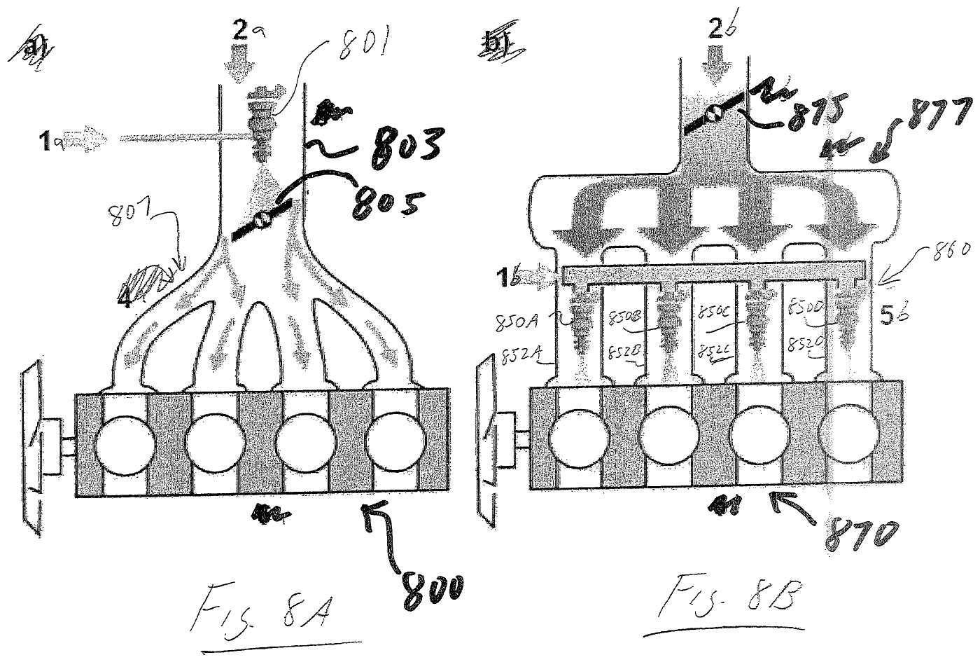

Referring now to FIGS. 8A and 8B, shown are two examples of placement of nozzles in an automotive four cylinder internal combustion engine according to embodiments of the present invention.

As seen in FIG. 8A, this embodiment may be utilized to inject fluid into the internal combustion engine 800 wherein a nozzle assembly 801 including the insert is located in the intake track 803 of the internal combustion engine 800. The nozzle assembly 801 (which receives pressurize fluid 1a) is positioned in the air intake track 803 prior to the air throttling mechanism 805. Intake air 2a flows through the intake track 803 and the fluid is injected into the air stream, which flows through four intake runners 807 and into the cylinders of the four cylinder internal combustion engine 800. A similar embodiment may utilize a plurality of nozzle assemblies in intake track 803.

FIG. 8B shows an embodiment utilizing a plurality of nozzle assemblies 850A, 850B, 850C and 850D including respective inserts that are located in each intake runner 852A, 852B, 852C and 852D for each individual cylinder of internal combustion engine 870. Intake air 2b flows into the intake track, past the air throttling mechanism 875 and into intake manifold 877. The air then flows into each individual intake runner 852A, 852B, 852C and 852D, where pressurized fluid 1b is injected through nozzle assemblies 850A, 850B, 850C and 850D into intake runner 852A, 852B, 852C and 852D of internal combustion engine 870. A similar embodiment may utilize a plurality of nozzle assemblies in each individual intake runner 852A, 852B, 852C and 852D.

In other embodiments, the disclosed nozzle assemblies may be used to deliver: (a) coffee or other beverages; (b) water, such as in the context of delivering water into an engine; and/or (c) adhesives.

In another embodiment, a valving means (or metering means) is not part of the disclosed nozzle assemblies.

In another embodiment, a valving means (or metering means) is not part of the disclosed inserts.

In another embodiment, a valving means (or metering means) is part of the disclosed nozzle assemblies.

In another embodiment, a valving means (or metering means) is part of the disclosed inserts.

As described herein, in one embodiment, the liquid jet collision is accomplished via a single nozzle (instead of by use of two or more separate nozzles).

As described herein, in one embodiment, the liquid jet collision is intended for liquid break up (instead of for mixing of two different liquids).

As described herein, in one embodiment, the liquid jet collision comprises colliding liquid streams against one another (instead of against a solid object).

As described herein, in one embodiment, the liquid jet collision relies on converging passages, and allows for the creation of sprays that emerge at an angle to the normal line of the nozzle.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. An apparatus for the delivery of a liquid, wherein the apparatus atomizes the liquid, the apparatus comprising:
an insert, the insert having a proximal end and a distal end, the insert including an insert body extending from the proximal end of the insert towards the distal end of the inert, the insert body having a minor diameter and an expanded section disposed adjacent the distal end of the insert, the expanded section having a plurality of passages;
a nozzle housing, the nozzle housing having a proximal end at which a liquid inlet is located and a distal end at which a liquid outlet is located, the nozzle housing having a cavity in which the insert is located; and
a source for feeding pressurized liquid into the liquid inlet of the nozzle housing;
wherein, in the nozzle housing, liquid flows from the liquid inlet through the cavity to the expanded section of the insert and then exits through the passages of the insert.

2. The apparatus of claim 1, wherein the insert body is cylindrical in shape on an outside thereof and the cavity is cylindrical shape on an inside thereof.

3. The apparatus of claim 1, wherein the insert body is cylindrical in shape on an outside thereof and wherein an outside of the insert body causes liquid flow to diverge away from a central axis of the nozzle housing.

4. The apparatus of claim 3, wherein a fluid-flow cavity is formed between the minor diameter of the insert body and an inner surface of the nozzle cavity, wherein the fluid-flow cavity extends from the proximal end of the insert toward the distal end of the insert and ends at the expanded section through which the plurality of passages are located.

5. The apparatus of claim 4, wherein the plurality of passages originate at the proximal end of the expanded section of the insert and are symmetrically distributed radially along a virtual circle at the distal end of the insert.

6. The apparatus of claim 5, wherein the plurality of passages are perpendicular to a concave conical surface at the distal end of the insert.

7. The apparatus of claim 6, wherein the concave conical surface forms a concave cone that is aligned to a longitudinal central axis of the insert.

8. The apparatus of claim 1, further comprising valving means for precisely controlling the flow of the liquid through the nozzle housing.

9. The apparatus of claim 8, wherein the valving means provides a precise quantity of liquid flow at a precise start time and a precise stop time.

10. The apparatus of claim 8, wherein the valving means is located internally in the nozzle housing.

11. The apparatus of claim 8, wherein the valving means is located externally to the nozzle housing.

12. The apparatus of claim 1, wherein an outer surface of the insert is a surface suitable for press fitment into the nozzle housing.

13. The apparatus of claim 1, wherein the distal end of the insert includes an o-ring groove at an axial surface of the distal end of the insert and wherein the o-ring groove provides a seat for an axial seal against the nozzle housing.

14. The apparatus of claim 1, wherein an outer surface of the insert is in proximity to the distal end of the insert and contains an o-ring groove on a radial surface, wherein the o-ring groove provides a seat for a radial seal against the nozzle housing.

15. The apparatus of claim 1, wherein:
the nozzle housing has a hole at the distal end of the nozzle housing;
the hole at the distal end of the nozzle housing is sized to prohibit the insert from passing through the hole;
wherein the insert is biased toward the distal end within the nozzle housing by a spring; and
wherein the spring traps the insert axially against an inner surface of the nozzle housing at the distal end of the nozzle housing.

16. The apparatus of claim 1, wherein the insert is welded to the nozzle housing.

17. The apparatus of claim 1, wherein an outer plate is welded to the nozzle housing to hold the insert in the nozzle housing.

18. An apparatus for the delivery of a liquid, wherein the apparatus atomizes the liquid, the apparatus comprising:
an insert, the insert having a proximal end and a distal end, the insert including an insert casing extending from the proximal end of the insert towards the distal end of the insert, the insert including an insert core disposed within the insert casing, the insert core extending from the proximal end of the insert towards the distal end of the inert, the insert core having a minor diameter and an expanded section disposed adjacent the distal end of the insert, the expanded section having a plurality of passages;
a nozzle housing, the nozzle housing having a proximal end at which a liquid inlet is located and a distal end at which a liquid outlet is located, the nozzle housing having a cavity in which the insert is located; and
a source for feeding pressurized liquid into the liquid inlet of the nozzle housing;
wherein, in the nozzle housing, liquid flows from the liquid inlet through the cavity to the expanded section of the insert and then exits through the passages of the insert.

19. The apparatus of claim 18, wherein an outer surface of the insert casing is threaded.

20. The apparatus of claim 19, wherein an inner surface of the nozzle housing is threaded such that the threads of the inner surface of the nozzle housing are configured to mate with the threads of the insert casing.

21. The apparatus of claim 20, wherein the distal end of the insert core includes a shoulder cap that protrudes radially outward from the insert, and wherein the shoulder cap is utilized as a stop against a surface of the nozzle housing when the insert casing is threaded into the nozzle housing.

22. The apparatus of claim 18, wherein the insert core is cylindrical in shape on an outside thereof and the insert casing is cylindrical shape on an inside thereof.

23. The apparatus of claim 22, wherein an outside of the insert core causes liquid flow to diverge away from a central axis of the nozzle housing.

24. The apparatus of claim 18, wherein a fluid-flow cavity is formed between the minor diameter of the insert core and an inner surface of the insert casing, wherein the fluid-flow cavity extends from the proximal end of the insert toward the distal end of the insert and ends at the expanded section through which the plurality of passages are located.

25. The apparatus of claim 24, wherein the plurality of passages originate at the proximal end of the expanded section of the insert core and are symmetrically distributed radially along a virtual circle at the distal end of the insert.

26. The apparatus of claim 25, wherein the plurality of passages are perpendicular to a concave conical surface at the distal end of the insert.

27. The apparatus of claim 26, wherein the concave conical surface forms a concave cone that is aligned to a longitudinal central axis of the insert.

28. The apparatus of claim 18, further comprising valving means for precisely controlling the flow of the liquid through the nozzle housing.

29. The apparatus of claim 28, wherein the valving means provides a precise quantity of liquid flow at a precise start time and a precise stop time.

30. The apparatus of claim 28, wherein the valving means is located internally in the nozzle housing.

31. The apparatus of claim 28, wherein the valving means is located externally to the nozzle housing.

32. An apparatus for the delivery of a liquid, wherein the apparatus atomizes the liquid, the apparatus comprising:
an insert, the insert having a proximal end and a distal end, the insert including an insert body extending from the proximal end of the insert towards the distal end of the insert, the insert body including a plurality of passages comprising at least a first passage and a second passage, the insert body having at least a first fluid flow channel and a second fluid flow channel, the first fluid flow channel being along an exterior surface of the insert in a longitudinal direction from the proximal end of the insert towards the distal end of the insert, the second fluid flow channel being along the exterior surface of the insert in the longitudinal direction from the proximal end of the insert towards the distal end of the insert, the first fluid flow channel being in fluid communication from the exterior surface of the insert to the first passage and the second fluid flow channel being in fluid communication from the exterior surface of the insert to the second passage;
a nozzle housing, the nozzle housing having a proximal end at which a liquid inlet is located and a distal end at which a liquid outlet is located, the nozzle housing having a cavity in which the insert is located, the nozzle housing having a hole at the distal end of the nozzle housing, and the hole at the distal end of the nozzle housing being sized to prohibit the insert from passing through the hole; and
a source for feeding pressurized liquid into the liquid inlet of the nozzle housing;
wherein, in the nozzle housing, liquid flows from: (a) the liquid inlet through the first fluid flow channel of the insert body and then exits through the first passage of the insert; and (b) the liquid inlet through the second fluid flow channel of the insert body and then exits through the second passage of the insert.

33. The apparatus of claim 32, wherein:
the insert is cylindrical in shape on an outside thereof;
the cavity is cylindrical shape on an inside thereof; and
a diameter of the hole at the distal end of the nozzle housing is smaller than a diameter of the exterior surface of the insert.

34. The apparatus of claim 32, wherein:
the first fluid-flow channel is in the form of a channel with a rectangular cross section with a width and a depth; and
the second fluid-flow channel is in the form of a channel with a rectangular cross section with a width and a depth.

35. The apparatus of claim 32, wherein:
the first fluid-flow channel is in the form of a channel with a semicircle section with an arc length and a height; and
the second fluid-flow channel is in the form of a channel with a semicircle section with an arc length and a height.

36. The apparatus of claim 32, wherein:
the first fluid-flow channel is in the form of a channel with a triangular section with a base and a height; and
the second fluid-flow channel is in the form of a channel with a triangular section with a base and a height.

37. The apparatus of claim 32, wherein the plurality of passages are symmetrically distributed radially along a virtual circle at the distal end of the insert.

38. The apparatus of claim 37, wherein the plurality of passages are perpendicular to a concave conical surface at the distal end of the insert.

39. The apparatus of claim 38, wherein the concave conical surface forms a concave cone that is aligned to a longitudinal central axis of the insert.

40. The apparatus of claim 32, further comprising valving means for precisely controlling the flow of the liquid through the nozzle housing.

41. The apparatus of claim 40, wherein the valving means provides a precise quantity of liquid flow at a precise start time and a precise stop time.

42. The apparatus of claim 40, wherein the valving means is located internally in the nozzle housing.

43. The apparatus of claim 40, wherein the valving means is located externally to the nozzle housing.

44. The apparatus of claim 32, wherein the exterior surface of the insert is a surface suitable for press fitment into the nozzle housing.

45. The apparatus of claim 32, wherein the distal end of the insert includes an o-ring groove at an axial surface of the distal end of the insert and wherein the o-ring groove provides a seat for an axial seal against the nozzle housing.

46. The apparatus of claim 32, wherein the exterior surface of the insert that is in proximity to the distal end of the nozzle housing contains an o-ring groove on a radial surface, wherein the o-ring groove provides a seat for a radial seal against the nozzle housing.

47. The apparatus of claim 32, wherein:
the insert is biased within the nozzle housing by a spring; and
wherein the spring traps the insert axially against an inner surface of the nozzle housing at the distal end of the nozzle housing.

48. The apparatus of claim 32, wherein the insert is welded to the nozzle housing.

49. The apparatus of claim 32, wherein an outer plate is welded to the nozzle housing to hold the insert in the nozzle housing.
